(19) United States
(12) Patent Application Publication
(10) Pub. No.: US 2014/0037984 A1
(43) Pub. Date: Feb. 6, 2014

(54) METHOD OF PREPARATION PRIOR TO THE WELDING OF LITHIUM-ALUMINIUM ALLOY PRODUCTS

(71) Applicant: CONSTELLIUM FRANCE, Courbevoie (FR)

(72) Inventors: Franck Eberl, Issoire (FR); Stephane Jambu, Chamalieres (FR); Christian Barthelemy, Voiron (FR); Gaelle Pouget, Grenoble (FR)

(73) Assignee: CONSTELLIUM FRANCE, Courbevoie (FR)

(21) Appl. No.: 13/894,188

(22) Filed: May 14, 2013

Related U.S. Application Data
(62) Division of application No. 13/002,153, filed on Dec. 30, 2010, now abandoned.

(30) Foreign Application Priority Data
Jul. 7, 2008 (FR) 08/03849

(51) Int. Cl. B23K 31/02; B32B 15/01

(52) U.S. Cl. CPC B23K 31/02; B32B 15/016
USPC 428/654; 148/535

(57) ABSTRACT

The present invention relates to aluminum-lithium alloys in general and, in particular, such products as used in the aircraft industry and the welding of these.

### CROSS REFERENCE TO RELATED APPLICATIONS

This application is a Divisional of U.S. application Ser. No. 13/002,153, filed Dec. 30, 2010; which is a §371 National Stage Application of PCT/FR2009/000830, filed Jul. 3, 2009, which claims priority to French application Ser. No. 08/03849, filed Jul. 7, 2008, the content of all of which are incorporated herein by reference in their entireties.

### BACKGROUND

1. Field of the Invention

The present invention relates to aluminum-lithium alloys in general and, in particular, such products as used in the aircraft industry and the welding of these.

2. Description of Related Art

Aluminum-lithium alloys (Al—Li) have long been recognized as an effective solution for reducing the weight of structural elements because of their low density. Their use is systematically considered for the most modern aeronautical structures. In addition, the use of welding instead of the usual techniques of riveting is also a current trend in the field of aeronautical engineering. It therefore goes without saying that in order to be used in aeronautical engineering, Al—Li alloys must preferably be able to be fusion-welded without difficulty.

U.S. Pat. No. 5,032,359 describes a family of weldable Al—Li alloys, the Aluminum-Copper-Lithium-Magnesium-Silver alloys. These alloys are also known under the trade name of “WELDALITE®” which particularly stresses their weldability. However, it was recognized in this initial patent and the later literature that this type of alloy was sensitive to the formation of porosities during welding. The mechanism behind this problem is poorly understood; it seems specific to Al—Li alloys.

It is known from the ASM Handbook “Aluminum”, 1991 pages 402-403 that a solution to this problem can be provided by carrying out preprocessing, typically surface etching of about 250 μm, just before welding. The porosities after welding are then observed to disappear. However this practice has several disadvantages: it requires a fairly long surface treatment stage before welding which complicates the manufacturing process and can lead to prohibitive investment in plants which are not equipped with surface treatment lines.

This treatment can prove to be difficult to perform homogeneously, in particular on extruded sections of complex shape. In addition, chemical etching of about 250 μm is difficult to perform accurately for thin parts, typically about 1 to 2 mm: etching on both faces may account for approximately 25 to 50% of the final thickness which presents technical problems for respecting thickness tolerances and must be taken into account for dimensioning the parts. Finally, this treatment causes a metal loss which is economically very unfavorable, in particular for thin parts of low thickness.

The document Ellis M B D “Fusion welding of aluminum-lithium alloys” Welding and Metal Manufacture, IPC LTD. HAYWARDS HEATH, GB vol 64, no 2, Feb. 1, 1996 page 44/56, 58, 60 also states that it is necessary to remove 0.2 mm from each face to carry out welding free from porosities on aluminum-lithium alloys.

The document Ryazantsev V I “Preparation of the surface of aluminum alloys for arc welding” Welding International, Taylor & Francis Abingdon, GB, vol. 16, no 9 Jan. 1, 2002 pages 744-749, describe various methods of preparing products made of aluminum alloy, in particular aluminum-lithium alloy, including stages of degreasing and chemical etching and solution heat treatment in a vacuum oven.

U.S. Pat. No. 6,881,491 describes a process for protecting an aluminum surface able to be coated in order to avoid blistering during heat treatment. This process is not intended for surface preparation before welding of aluminum lithium alloys.

In the same way, patent application EP-A-0 882.809 indicates treatments containing small quantities of fluorine to prevent oxidation, but does not reveal their use before welding or for aluminum-lithium alloys.

There therefore exists a need for a process for preparing aluminum lithium alloy parts for being welded, which makes it possible to avoid the formation of porosities in welds while avoiding all the disadvantages related to surface etching.

### SUMMARY

The subject of the invention is a process for preparing an aluminum lithium alloy product for it to be fusion-welded, including the successive stages of:

(i) procuring a hot-worked aluminum alloy product including at least 0.8% of lithium by weight,

(ii) optionally cold-working the product so obtained,

(iii) cleaning at least one surface to be welded of the product so obtained,

(iv) covering at least one cleaned surface of the product so obtained with a coating whose characteristics when dry are a quantity ranging between 0.1 and 5 mg/cm2 and preferably between 0.5 and 4 mg/cm2, and a fluorine concentration of at least 10% by weight,

(v) performing a solution heat-treatment at a temperature greater than approximately 450° C. followed by quenching of the product so obtained.

Another subject of the invention is a fusion-welded assembly between a first aluminum alloy member including at least 1.4% of lithium by weight and at least one second metal alloy member, the first member being a flat-rolled or extruded product of thickness less than 5 mm and preferably less than 2 mm, the first member having been prepared by the process according to the invention, characterized in that the weld is substantially free from porosities.

Still another subject of the invention is a fuselage panel including an assembly welded according to the invention.

### BRIEF DESCRIPTION OF THE DRAWINGS

FIG. 1: classification of quality in terms of porosity of the welded joints

FIG. 2: profiles used for the tests

### DETAILED DESCRIPTION OF A PREFERRED EMBODIMENT

Unless otherwise stated, all the indications concerning the chemical composition of the alloys are expressed as a percentage by weight based on the total weight of the alloy. The designation of alloys is compliant with the rules of The Aluminium Association, known to experts in the field. The definitions of metallurgical states are indicated in European standard EN515. Unless otherwise stated, the definitions of standard EN 12258-1 apply. The thicknesses of extruded products are defined according to standard EN2066.

Dry coating is taken to mean the state reached by the coating when it is dry throughout its thickness as defined by standard ISO 9117-90, which is different from a coating that is dry on the surface while the great majority of the coating has not yet stabilized.

The process according to the present invention is a process for preparing an aluminum lithium alloy product to be fusion-welded. Fusion welding is taken to mean processes, such as spot welding, flash welding, laser welding, arc welding, electron beam welding, in which welding is carried out above the melting point of the aluminum-lithium alloy, in the liquid phase. Within the framework of this invention, aluminum-lithium alloy is taken to mean alloys including at least 0.8% of lithium by weight. The process according to the invention is particularly advantageous for alloys including at least 1.4% of lithium by weight. Advantageously the process according to the present invention is applied to an alloy product selected from the group made up of alloys 2090, 2091, 2196, 2097, 2197, 2297, 2397, 2099, 2199, 8090, 8091, 8093. In a preferred embodiment, the process according to the invention is applied to an alloy 2196 product.

In the first stage, a hot-worked aluminum lithium alloy product is procured. Hot-working is taken to mean an operation for deforming a block obtained for example by semi-continuous casting. Hot-working of aluminum lithium alloys is carried out typically at an initial welding temperature greater than 350° C. or 400° C. Hot-working operations are typically rolling, extruding and forging. In a preferred embodiment of the invention, the hot-working operation is hot extruded.

In a second optional stage the hot-worked product can then be cold-worked in order to obtain a thinner product. Cold-worked operations are for example cold rolling, drawing and/or hammering.

At least one surface intended to be welded of the hot-worked and optionally cold-worked product is then cleaned. The purpose of cleaning is to eliminate the main residues from the hot-working stages. These residues are primarily hot-working oils and particles: oxides and/or metal particles. Cleaning can be carried out by any means suitable for eliminating these residues. Cleaning is not surface etching, so the thickness of metal eliminated during cleaning is less than 20 μm per side and preferably less than 10 μm per side. Chemical cleaning is typically carried out using an organic solvent such as for example an alcohol, a ketone or an alkane, or an alkaline grease-remover such as for example a grease-remover containing soda, potash or sodium carbonate, or an acid grease-remover, for example a grease-remover containing chromic acid, sulfuric acid or phosphoric acid. Several types of cleaning can be combined. However the present inventors noted that the combination of various cleaning operations, for example the combination of an alkaline cleaning and an acid cleaning, did not provide any technical advantage and uselessly complicated the process. Preferably cleaning is therefore carried out using one only family: cleaning by organic solvent or cleaning by alkaline degreasing or cleaning by acid degreasing. In an advantageous embodiment of the invention, cleaning is carried out by treatment with an aqueous solution with a pH greater than 9. Cleaning can be followed by surface rinsing, for example with demineralized water.

The surface so cleaned is then covered with a coating whose characteristics when dry are a quantity ranging between 0.1 and 5 mg/m2 and preferably between 0.5 and 4 mg/cm2, and a fluorine concentration of at least 10% by weight, and preferably of at least 25% by weight.

The coating can be deposited in the form of a solution, typically by immersion or spraying or in the form of powder, typically by electrostatic powdering. In the case of depositing a solution, the solvent is then evaporated by any suitable means in order to obtain a dry coating. In the case of a deposit in the form of powder, a dry coating can be obtained directly. Many fluorinated substances can be used to reach the desired fluorine concentration in the dry coating. Advantageously, the fluorine is in the form of a metal fluorine salt or a fluorinated compound. Useful examples of salts within the framework of the invention are given in Table 1. Fluxes of the Nocolok® brand can be used advantageously. Most are products containing aluminum and potassium fluoride with the general formula KₓAl_{y}F_{z} possibly containing various additives.

TABLE 1
Examples of fluorinated substances.

| | Molecular | | Melting (° C.) or |
|---|---|---|---|
| | weight | Relative density | decomposition |
| Fluorinated substance | (g) | (H₂0 = 1) | (d) point |
| NaBF4 | 109.79 | 2.47 | d 384 |
| K2SiF6 | 220.27 | 2.665 | d |
| KBF4 | 125.9 | 2.498 | d 350 |
| NH4HF2 | 57.04 | 1.5 | 125.6 |
| A1F3 | 83.98 | 2.882 | 1291 |
| CaF2 | 78.06 | 3.18 | 1423 |
| BaF2 | 175.53 | 4.89 | 1355 |
| BaSiF6 | 279.41 | 3.21 | d |
| Na2SiF6 | 188.06 | 2.679 | d |
| Cryolite 3NaF, A1F3 | | 2.2 | 1040 |
| Nocolok ® FLUX | | 2.8 | 565 to 572 |
| KxAlyFz | | | |
| Nocolok ® Cs | | 2.8-3 | 558-568 |
| FLUX TM | | | |
| KxAlyFz >=95% | | | |
| CsxAlyFz <5% | | | |
| Nocolok ® Zn | | 2.8 | 565-572 |
| FLUX KZnF3 >99% | | | |

Preference is given to products that at least partially decompose during the solution heat treatment in order not to hinder the fusion welding. However, the present inventors noted that the residues of certain fluorinated substances, and in particular substances containing potassium and aluminum fluoride did not cause any difficulty during fusion welding, probably because of their melting point lower than the melting point of aluminum alloys. The addition of a cesium and aluminum fluoride is advantageous.

Advantageously, the coating comprises a binder whose concentration when dry lies between 5% and 50% by weight. The binder makes it possible to obtain a homogeneous and reproducible deposit of the fluorinated substance. For coatings deposited from an aqueous solution, a thickener is typically used, such as for example those used in the food, cosmetic or painting industry. Carboxymethyl cellulose is a useful binder within the framework of the invention. A coupling agent can also advantageously be used in coatings deposited from an aqueous solution. Of the coupling agents, silanes are particularly advantageous. According to the invention, silane can be any silane of general formula R′Si (OR)3, where R′ is a group containing at least one organic radical and where OR is an alkoxy radical. Preferably, an aminosilane or an epoxy silane is used, such as, for example, the silanes AMEO (3-aminopropyltriethoxysilane) or Glymo: (3-glycidopropyltrimethoxysilane). For coatings deposited in powder form, the binder is typically a polymeric compound. Useful polymers within the framework of the invention comprise epoxy resins, polyurethane resins, polyolefin resins, polyacrylate resins, polyester resins, latexes, alkyl silicone resins and polyisocyanate resins. The use of alkyl silicone resins is preferred.

In one embodiment of the invention the coating is deposited from an aqueous solution and comprises when dry, as a percentage by weight, between 75% and 95% of NaBF₄, between 0 and 15% of carboxymethyl cellulose and between 0 and 15% of a silane. Advantageously, the coating according to this first embodiment does not comprise any other compounds than NaBF4, carboxymethyl cellulose and silane. In a second embodiment of the invention, the dry coating deposited preferably by electrostatic powdering comprises, as a percentage by weight, between 50% and 100% of K_{X}Al_{Y}F_{Z}, between 0 and 5% of CsₓAl_{y}F and between 0 and 50% by weight of a binder, preferably an alkyl silicone resin. Advantageously, the coating according to this first embodiment does not comprise any other compound than K_{X}Al_{Y}F_{Z}, CsₓAl_{y}F, a binder.

Cleaning and coating deposit are not necessary over all the surface of the product because the invention relates to the improvement of the quality of the welded joint and only surfaces intended to be welded therefore require treatment. However, it may be advantageous to carry out these cleaning and deposit stages on the majority or preferably on all the surface of the product, because this has an advantage in terms of simplicity and reproducibility of the treatment.

After depositing the coating, solution heat-treatment is performed at a temperature higher than approximately 450° C. followed by quenching. This is a conventional operation on aluminum-lithium alloys which is carried out in ambient air or in a more slightly oxidizing atmosphere such as one including argon, helium, C02, nitrogen, alone or in a mixture. An advantage of this invention is to obtain welds without porosities whatever the atmosphere used during the solution heat-treatment. The invention may also be advantageous if one carries out intermediate softening heat treatments at a temperature higher than 250° C. or 300° C. during the stages of cold working, for example, between cold rolling runs for sheets or drawing for tubes. Optionally, at least one surface covered with a coating of the product placed in the solution obtained in this way is cleaned. During the solution heat-treatment and quenching stages the coating is at least partially removed. In certain cases, residues of the coating remain present on the surface. These residues may give an undesirable appearance to the product and/or prove to be awkward during welding operations. They may, if necessary be cleaned, the conditions of cleaning already described being suitable. On this point, the coatings including a fluorinated substance of the NaBF4 or KBF4 type are advantageous because in the conditions of the invention, no visually apparent residues remain after solution heat-treatment and quenching. The coatings including a fluorinated substance of type KₓAl_{y}F_{z} and/or CsₓAl_{y}F_{z} are also advantageous because in the residues which remain after solution heat-treatment and quenching the welding operations do not hinder fusion.

After or before the optional cleaning stage which follows the solution heat-treatment, cold working and/or leveling and/or straightening and/or forming and/or aging usual for this type of product can if necessary be performed. The product resulting from the preparing process according to the invention is ready to be fusion-welded. Fusion welding is carried out using any fusion welding technique. In one embodiment of the invention, fusion welding is performed by laser welding in an inert atmosphere. The preparation made confers great stability on the aluminum-lithium alloy product. Fusion welding can if necessary be carried out several weeks after the end of the treatment. Preparation of the product according to the invention means that fusion welds substantially free from porosities are obtained.

As it is not well understood why welds made on aluminum-lithium alloys have a high propensity to form porosities, the mechanism explaining the effectiveness of the treatment according to the invention is particularly difficult to elucidate. Without being tied to any particular theory, the present inventors believe that the coating interacts synergistically with hydrogen in the atmosphere and lithium in the alloy, during solution heat-treatment.

The invention is particularly advantageous when the hot-worked and optionally cold-worked product is a flat-rolled or extruded product with thickness lower than 5 mm and preferably lower than 2 mm. The thinner the product, the trickier it is to carry out the known process of etching before welding reliably, and the harder it becomes to respect the thickness tolerances of the product.

The invention therefore makes it possible to manufacture a fusion welded assembly, with a weld substantially free from porosities between a first aluminum alloy member including at least 1.4% of lithium by weight and at least one second metal alloy member, in which the first member is a flat-rolled or extruded product of thickness less than 5 mm and preferably less than 2 mm, the first member having been prepared by the process according to the invention. Advantageously, the thickness tolerance of the first member is plus or minus 0.20 mm, preferably plus or minus 0.15 mm and preferably still plus or minus 0.10 mm. The first member and the second member are worked products, typically a extruded section, a sheet, a tube, a bar or a forged part. The possibility of obtaining such a thickness tolerance, in particular for products of low thickness, is a technical advantage of the invention because with processes according to prior art, using chemical etching of 0.2 mm to 0.25 mm on each face which can account for approximately 25 to 50% of the final thickness of the product, it is difficult to obtain such tolerances. The invention is particularly advantageous when the two members of the welded assembly are made of aluminum-lithium alloy, as it is more difficult in this case to obtain welds substantially free from porosities. In an advantageous embodiment of the invention, the welded joint comprises at least one second aluminum alloy member including at least 0.8% of lithium by weight.

In another embodiment of the invention, the second member is a titanium alloy and the assembly is preferably a “welding-brazing” operation in which the aluminum lithium alloy member undergoes fusion but not the titanium alloy member. In still another embodiment, the second member is, in any product, weldable by fusion with the first member, in particular any aluminum alloy.

In an advantageous embodiment of the invention the first member is a extruded section, preferably made of alloy 2196 and the second member is a sheet or a extruded section.

Assemblies welded according to the invention find particularly advantageous applications in aeronautical engineering with regard to the manufacture of structural elements. The term “structural element” refers to an element used in mechanical engineering for which the mechanical, static and/or dynamic characteristics are of particular importance for the performance and the integrity of the structure, and for which a structural analysis is generally prescribed or carried out. These are typically mechanical parts the failure of which is likely to endanger the safety of said construction, its users or others. For an aircraft, these structural elements comprise the parts which make up the fuselage (such as the fuselage skin, stringers, bulkheads, circumferential frames), the wings (such as the wing skin, stringers or stiffeners, ribs and spars) and the tail unit, made up of horizontal and vertical stabilizers, as well as floor beams, seat tracks and doors.

In a preferred embodiment, the assemblies welded according to the invention are used for the manufacture of fuselage panels.

### Example 1

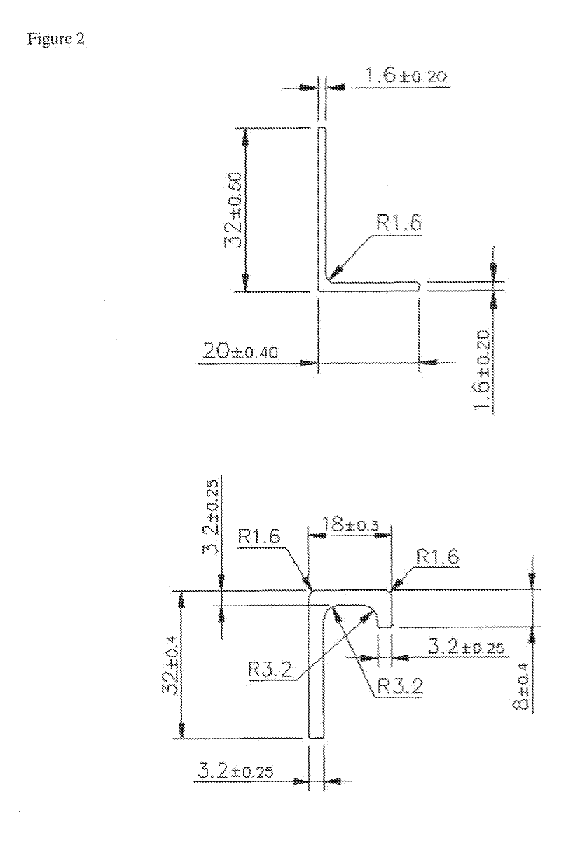

In this example, extruded sections made of alloy AA2196, thickness 1.6 mm and 3.2 mm in state T4 were fusion welded. The extruded sections of thickness 1.6 mm and thickness 3.2 mm are shown in FIG. 2. Solution heat-treatment was 45 minutes at 524° C. The welding lines were made by laser welding with a filler wire made of alloy 4047, a power level of 2300 W and a welding speed of 5.4 m/min, in an atmosphere made up of a mixture of Ar (30%) and He (70%). Etching with a controlled thickness ranging between 0 and 300 μm per face was carried out using an alkaline etching solution.

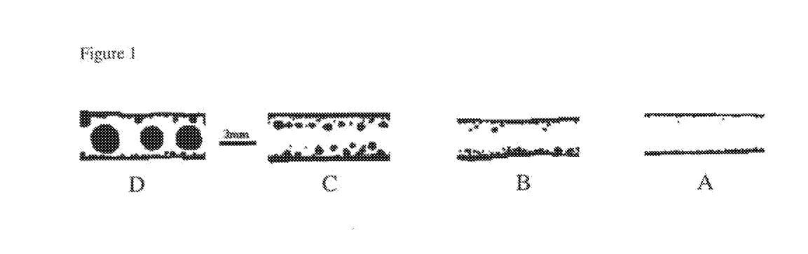

The presence of porosities in the welds obtained was characterized by x-ray imagery. FIG. 1 illustrates 4 levels of porosities used to evaluate the results obtained. Level A corresponds to the presence of at the most a very low number of pores, the welding is substantially free from porosities, and weld quality is good. Level B corresponds to a higher pore density than that of level A, the pore diameter remaining lower than 0.5 mm. Level C corresponds to a still higher density than that of level B, the pore diameter remaining lower than 1.5 mm. Level D corresponds to a high pore density, certain pores having a diameter greater than 1.5 mm.

The results obtained are presented in table 2. Etching of 200 μm to 250 μm proves to be necessary to obtain welded assemblies substantially free from porosities.

TABLE 2
Quality of the welded assemblies for various etching conditions

| | Extruded sections | | Extruded sections | |
|---|---|---|---|---|
| | of thickness 1.6 mm | | of thickness 3.2 mm | |
| | Sample | Weld quality in | Sample | Weld quality in |
| Etching | Reference | terms of porosity | Reference | terms of porosity |
| 0 μm | Ml | D | El | C |
| 20 μm | M2 | D | E2 | D |
| 50 μm | M3 | D | E3 | C |
| 100 μm | M4 | C | E4 | B |
| 200 μm | M5 | A | E5 | B |
| 250 μm | M6 | A | E6 | A |
| 300 μm | M7 | A | E7 | A |

### Example 2

In this example, extruded sections made of alloy AA2196, thickness 1.6 mm the cross-section of which is described in FIG. 2 were coated with the products indicated in table 3, after cleaning in an alkaline medium followed by rinsing in de-ionized water and neutralization treatment in 58% by volume nitric acid for 1 minute and rinsing in de-ionized water. After drying the coating, the amount deposited was measured and the extruded sections underwent solution heat treatment and were quenched before undergoing welding lines in conditions identical to those of example 1. The results in terms of the quality of the welded assembly are also indicated in table 3.

TABLE 3
Coating conditions used

| | | | | | | | Weld |
|---|---|---|---|---|---|---|---|
| | | | | | | Amount | quality in |
| | | | Binder | | Coating | deposited | terms of |
| Reference | Active substance | Binder 1 | 2* | Solvent | technique | (mg/cm2) | porosity |
| AAl | | | | | | | C |
| AA2 | | | | | | | D |
| BBl | NaBF4 | Glymo silane | CMC | water | immersion | 0.63 | B |
| | 161.5 g/kg | 10 g/kg | 6.75 g/l | | | | |
| BB2 | NaBF4 | Glymo silane | CMC | water | immersion | 0.62 | B |
| | 161.5 g/kg | 10 g/kg | 6.75 g/l | | | | |
| LL1 | NaBF4 | Glymo silane | CMC | water | immersion | 0.4 | A-B |
| | 161.5 g/kg | 5 g/kg | 6.75 g/l | | | | |
| LL2 | NaBF4 | Glymo silane | CMC | water | immersion | 0.37 | A-B |
| | 161.5 g/kg | 5 g/kg | 6.75 g/l | | | | |
| CC1 | NaBF4 | SILRES ® | 0 | no | Electrostatic | 1.66 | B |
| | 845 g/kg | MK 155 g/kg | | | powdering | | |
| CC2 | NaBF4 | SILRES ® | 0 | no | Electrostatic | 1.29 | B |
| | 845 g/kg | MK 155 g/kg | | | powdering | | |
| JJ1 | KBF4 | Glymo silane | CMC | water | immersion | 0.1 | C |
| | 169 g/kg | 10 g/kg | 6.75 g/l | | | | |
| JJ2 | KBF4 | Glymo silane | CMC | water | immersion | 0.13 | B |
| | 169 g/kg | 10 g/kg | 6.75 g/l | | | | |
| DD1 | B203 | SILRES ® | 0 | no | Electrostatic | 2.67 | B |
| | 60 g/kg | MK 50 g/kg | | | powdering | | |
| DD2 | B203 | SILRES ® | 0 | no | Electrostatic | 1.77 | B |
| | 60 g/kg | MK 50 g/kg | | | powdering | | |
| GG1 | TiB2 | SILRES ® MK | 0 | no | Electrostatic | 1.17 | D |
| | 100 g/kg | 17 g/kg | | | powdering | | |
| GG2 | TiB2 | SILRES ® MK | 0 | no | Electrostatic | 0.98 | D |
| | 100 g/kg | 17 g/kg | | | powdering | | |
| KK1 | TiB2 100 g/kg | AMEO silane | 0 | water | Brush | 7.6 | D |
| | | 10 g/kg | | | | | |
| KK2 | TiB2 | AMEO silane | 0 | water | Brush | 6.6 | D |
| | 100 g/kg | 10 g/kg | | | | | |

*CMC: carboxymethyl cellulose
AMEO silane: 3-aminopropyltriethoxysilane
Glymo silane: 3-glycidopropyltrimethoxysilane

Compared to the AA1 and AA2 reference samples, the majority of the samples tested show an improvement in the porosity of the welded assemblies apart from those samples for which the active substance is TiB2. The samples treated with B2O3 have many surface residues after solution heat-treatment.

### Example 3

Extruded sections of thickness 1.6 mm made of alloy AA2196, of cross-section identical to that of the preceding examples were obtained by casting billets the composition of which is supplied and extruding at a temperature greater than 400° C. Surface preparation treatments before solution heat-treatment were carried out. First of all the extruded sections were cleaned in an alkaline solution, followed in certain cases by treatment in an acid solution. Three types of treatments were then carried out: a first treatment containing sodium fluoroborate (NaBF4), a second treatment containing boron oxide and a third treatment based on aluminum and potassium fluoride (KXAlYFZ). The KXAlYFZ treatment contained the flux referenced by Nocolok®Cs FLUX™, this flow containing between 95 and 100% of aluminum and potassium fluoride K2AlF5 and less than 5% of cesium fluoroaluminate CSAlF4. A polyméthylsiloxane resin SILRES® MK powder by Wacker Chimie was added in certain compositions.

Glymo silane (glycidopropyltrimethoxysilane) was added to the first treatment. In addition, various solution heat-treatment conditions were used. Two furnace atmospheres were tested: a standard atmosphere and a deliberately humidified atmosphere, in order to create more severe conditions.

The conditions used and the results obtained are given in Table 4.

TABLE 4
Coating conditions used

| | | | | Solution | Weld |
|---|---|---|---|---|---|
| | Alkaline | Acid | | heat | quality |
| | cleaning^{a} | treatment^{b} | Coating | treatment^{d} | (porosity)^{e} |
| El | No | No | No | 1 | C |
| E2 | No | No | No | 2 | D |
| E3 | Yes | No | NaBF4 | 1 | A |
| E4 | Yes | No | NaBF4 | 2 | C |
| E5 | Yes | Yes | NaBF4 | 1 | A |
| E6 | Yes | Yes | NaBF4 | 2 | C |
| E7 | Yes | No | B203 | 1 | D |
| E8 | Yes | No | B203 | 2 | B-D |
| E9 | Yes | Yes | B203 | 1 | A-D |
| E10 | Yes | Yes | B203 | 2 | C |
| E11 | Yes | No | K_{X}Al_{Y}F_{Z} | 1 | A |
| E12 | Yes | No | K_{X}Al_{Y}F_{Z} | 2 | A |

^{a}5 min at 60° C. in a Novaclean Al 708 ® solution, pH = 11 followed by rinsing with demineralized water
^{b}1 min in a nitric acid solution (50% by volume) followed by rinsing in demineralized water
c) NaBF₄: “NaBF₄: 161 g/kg-glymo silane 10 g/kg-Wetting coating: Thickener CMC 9 g/kg Water: 814 g/kg-0.8 to 1 mg/cm2 (immersion)” B203: “B2O3 (55% by weight) SILRES ® MK powder (45% by weight)-3 to 4.7 mg/cm²- Electrostatic powdering” >=95% K2AlF5 + <5% CsAlF4 “Nocolok ®Cs FLUX TM (70% by weight) SILRES ® MK powder (30% by weight)-2 to 3.5 mg/cm²-Electrostatic powdering”
^{d}1.: 45 min 524° C. - standard air 2: 45 min 524° C. - humid air
^{e}See FIG. 1

In the absence of surface treatment before solution heat-treatment, porosities are present in all cases.

The NaBF4 treatment makes it possible to obtain satisfactory results in the majority of cases. Only the most severe conditions (45 min 524° C.—humid air) lead to a level C porosity density. It is also to be noted that acid treatment after the cleaning operation in an alkaline medium does not provide any advantage, exactly identical results being obtained with or without this additional treatment. The B203 treatment did not make it possible to obtain favorable results homogeneously and reproducibly. For this reason, several levels of porosity density observed locally have been indicated. In addition, many residues are to be observed on the surface after the stages of solution heat-treatment and quenching. Additional cleaning (alkaline cleaning and acid treatment) of the surface after solution heat-treatment and quenching and before welding makes it possible to eliminate the majority of these residues and then an improvement in the porosity density is to be observed, without however reaching an acceptable level A quality homogeneously and reproducibly.

The KXAlYFZ treatment gave excellent results (level A) for all the conditions of solution heat-treatment tested. In addition, the absence of residues detrimental for welding on the surface means that it is not necessary to carry out cleaning treatment after solution heat-treatment.

1. A fusion-welded assembly comprising
(a) a first aluminum alloy member comprising at least 1.4% of lithium by weight;
(b) at least one second metal alloy member, wherein the weld between the first and second alloy member is substantially free from porosities; and wherein
(c) said first aluminum alloy member being a flat-rolled or extruded product of a thickness less than 5 mm, the first member having been prepared by (i)-(vi) in order:
(i) procuring a hot-worked aluminum alloy product including at least 0.8% of lithium by weight,
(ii) optionally cold-working the product so obtained,
(iii) cleaning at least one surface to be welded of the product so obtained,
(iv) covering at least one cleaned surface of the product so obtained with a coating whose characteristics when dry are a quantity ranging from 0.1 to 5 mg/cm² and a fluorine concentration of at least 10% by weight,
(v) performing a solution heat-treatment at a temperature greater than approximately 450° C. followed by quenching of the product so obtained, and
(vi) fusion welding a first alloy member obtained by steps (i) to (v) to at least one second metal alloy member to form said fusion welded assembly, wherein the weld between said first alloy member and said at least one second metal alloy member is substantially free from porosities.

2. The fusion-assembly according to claim 1 in which the thickness tolerance of said first member is plus or minus 0.20 mm.

3. The fusion-assembly according to claim 1 comprising at least one second aluminum alloy member including at least 0.8% of lithium by weight.

4. The fusion-assembly according to claim 1 in which said first member is an extruded section and said second member is a sheet or an extruded section.

5. A fuselage panel comprising a welded assembly according to claim 1.

6. The fusion-assembly according to claim 1 in which the thickness tolerance of said first member is plus or minus 0.15 mm.

7. The fusion-assembly according to claim 1 in which the thickness tolerance of said first member is plus or minus 0.10 mm.

8. The fusion-assembly of claim 1, wherein said first member comprises a flat-rolled or extruded product of a thickness less than 2 mm.

9. A process for preparing a fusion welded assembly comprising an aluminum lithium alloy product comprising in the following order:
(i) procuring a hot-worked aluminum alloy product including at least 0.8% of lithium by weight,
(ii) optionally cold-working the product so obtained,
(iii) cleaning at least one surface to be welded of the product so obtained,
(iv) covering at least one cleaned surface of the product so obtained with a coating whose characteristics when dry are a quantity ranging from 0.1 to 5 mg/cm² and a fluorine concentration of at least 10% by weight,
(v) performing a solution heat-treatment at a temperature greater than approximately 450° C. followed by quenching of the product so obtained, and
(vi) fusion welding a first alloy member obtained by steps (i) to (v) to at least one second metal alloy member to form said fusion welded assembly, wherein the weld between said first alloy member and said at least one second metal alloy member is substantially free from porosities.

10. The process according to the claim 9 in which said aluminum lithium alloy comprises at least 1.4% of lithium by weight.

11. The process according to claim 9 in which said aluminum lithium alloy is selected from the group consisting of alloys 2090, 2091, 2196, 2097, 2197, 2297, 2397, 2099, 2199, 8090, 8091, and 8093.

12. The process according to claim 9 in which the hot-worked and optionally cold-worked product is a flat-rolled or extruded product with thickness lower than 5 mm.

13. The process according to claim 9 in which the cleaning of (iii) is carried out by treating with an aqueous solution with a pH greater than 9.

14. The process according to claim 9 in which (iii) and (iv) are carried out on the majority of, or optionally on the whole, surface of said product.

15. The process according to claim 9 in which said coating comprises a binder whose concentration when dry ranges from 5% to 50% by weight.

16. The process according to claim 9 in which said coating comprises when dry, as a percentage by weight, from 75% to 95% of NaBF4, from 0 to 15% by weight of carboxymethyl cellulose and from 0 to 15% of a silane.\

17. The process according to claim 9 in which said coating comprises after drying, as a percentage by weight, from 50% to 100% of KxAlyFz, from 0 to 5% by weight of CsxAlyFz and from 0 to 50% of a binder.

18. The process according to claim 9 in which said binder is an alkyl silicone resin.

19. The process according to claim 9, wherein the weld between said first alloy member and said at least one second metal alloy member is without porosities.

20. Process for preparing a fusion welded assembly comprising an aluminum lithium alloy product comprising in the following order:
(i) procuring a hot-worked aluminum alloy product including at least 0.8% of lithium by weight,
(ii) optionally cold-working the product so obtained,
(iii) cleaning at least one surface to be welded of the product so obtained,
(iv) covering at least one cleaned surface of the product so obtained with a coating whose characteristics when dry are a quantity ranging from 0.1 to 5 mg/cm² and a fluorine concentration of at least 10% by weight,
(v) performing a solution heat-treatment at a temperature greater than approximately 450° C. followed by quenching of the product so obtained,
(vi) fusion welding a first alloy member obtained by steps (i) to (v) to at least one second metal alloy member to form said fusion welded assembly, wherein the weld between said first alloy member and said at least one second metal alloy member is substantially free from porosities, and
wherein the thickness of metal eliminated during cleaning is less than 20 μm per side.
